(19) United States
(12) Patent Application Publication
(10) Pub. No.: US 2011/0083106 A1
(43) Pub. Date: Apr. 7, 2011

(54) IMAGE INPUT SYSTEM

(75) Inventor: Goro HAMAGISHI, Toyonaka-shi (JP)

(73) Assignee: SEIKO EPSON CORPORATION, Tokyo (JP)

(21) Appl. No.: 12/897,497

(22) Filed: Oct. 4, 2010

(30) Foreign Application Priority Data
Oct. 5, 2009 (JP) 2009-231224

(51) Int. Cl. G06F 3/048; H04N 13/02

(52) U.S. Cl. 715/836; 348/47; 348/E13.021

(57) ABSTRACT

An image input system includes: a display device that displays a three-dimensional image; a plurality of cameras; a controller that controls the display device and the plurality of cameras, wherein the controller causes the display device to display the three-dimensional image that includes a plurality of icons, the controller performs analysis processing on the plurality of images picked up by the plurality of cameras to obtain and output analysis information that contains three-dimensional position information regarding a most protruding part at a side of the user, the plurality of icons includes icons of which positions in a depth direction in the three-dimensional image are not the same, and each icon can be identified from the other icons or can be selected out of the icons of which the positions in the depth direction are not the same.

### BACKGROUND

1. Technical Field

The present invention relates to an image input system that uses a three-dimensional image.

2. Related Art

These days, in the field of a mobile phone, a portable music player, or the like, touch-type models, that is, a device equipped with a touch panel on a display screen, are popular. A user can directly touch icons (manual operation menu) displayed on a display screen. Upon the touching of an icon, a function that is assigned to the icon is executed. Such touch operation is user friendly because of its easiness.

Since it is necessary for a user to directly touch a screen for operation, a touch panel has been mainly used for a handheld electronic device such as a mobile phone or a non-remote electronic device, where the non-remote electronic device means a device that is generally installed within the reach of a user, for example, a car navigation system. On the other hand, as a large-sized television that has a large screen of several dozen of inches, a home projector, and the like come into wide use in ordinary households, there is a demand for an inputting means that offers an excellent user interface such as a touch panel not only for handheld and non-remote electronic devices but also for large-sized televisions and the like.

To meet such a demand, a technique for displaying a cursor-like image has been proposed in the art. The cursor-like image is displayed on a projected image on the extension of a virtual line segment that is drawn when a user points a finger at the projection screen. An example of the related art is disclosed in JP-A-5-19957. Specifically, in the technique disclosed therein, two cameras having different visual angles are used to detect the position of the body of a user and the position of a hand of the user by performing image recognition processing. A virtual line segment that connects substantially the center of the body and the tip of the hand is drawn. A cursor-like image is displayed on a screen at a point where the extended line intersects with the screen. An image recognition system having the following features is disclosed in JP-A-2008-225985. Similar to the related art described above, two cameras are used to pick up images of the entire body of a user. Image recognition processing is performed on the images to detect a motion of the user, for example, the raising of one hand of the user. The detected motion of the user is displayed on the screen of a display device that is installed at a distance from the user. As another function, the image recognition system disclosed in JP-A-2008-225985 enables the user to move a character in a video game in accordance with the motion. Both of the projected image and the display image in the above techniques are two-dimensional (2D) images. On the other hand, recently, various types of display devices and display systems that display three-dimensional (3D) images have been proposed.

However, the use of a 3D image as a means for inputting is not taken into consideration at all in the related techniques described above. For example, in the related art disclosed in JP-A-5-19957, even though the direction of the pointing of a finger by a user is detected in three dimensions, a cursor is displayed at a detected position merely on a two-dimensional projected image. Therefore, the disclosed technique is based on nothing more than biaxial two-dimensional position information in a two-dimensional plane. In the related art disclosed in JP-A-2008-225985, since the motion of a user is detected in three dimensions to regard the detected motion as an instruction for operation, a 3D image is not used for inputting. In the concept of a 3D image, besides X-Y plane coordinates, there is a coordinate axis in the depth direction, which is represented by the Z axis. The use of the Z axis is not considered at all in the above related-art documents. That is, an image input system that uses a 3D image is not disclosed therein. In the related art, though a motion of a user can be detected so as to execute some sort of a function depending on the detected mode, it is not clear how much the disclosed system is user friendly because there is not any description regarding an operation menu (icons) displayed on a display screen in the document. That is, the related art has a problem in that no consideration is given to the operationality (user friendliness) of an input system.

### SUMMARY

In order to address the above-identified problems without any limitation thereto, the invention provides, as various aspects thereof, an image input system having the following novel and inventive features.

### APPLICATION EXAMPLES

An image input system according to an aspect of the invention includes: a display device that displays a three-dimensional image; a plurality of cameras that picks up a plurality of images of a user who faces the three-dimensional image at different visual angles; a controller that controls the display device and the plurality of cameras, wherein the controller causes the display device to display the three-dimensional image that includes a plurality of icons for operation, the controller performs analysis processing on the plurality of images picked up by the plurality of cameras to obtain and output analysis information that contains three-dimensional position information regarding a most protruding part at a side of the user, the part protruding toward the three-dimensional image, the plurality of icons includes icons of which positions in a depth direction in the three-dimensional image are not the same, and each icon can be identified from the other icons or can be selected out of the icons of which the positions in the depth direction are not the same by using the three-dimensional position information that contains position information in the depth direction.

The plurality of icons displayed in a three-dimensional image includes icons of which positions in the depth direction in the three-dimensional image are not the same. Each icon can be identified from the other icons (selected) by using three-dimensional position information that contains information on its position in the depth direction. That is, unlike a conventional input system that identifies an icon on the basis of biaxial two-dimensional position information in a two-dimensional plane only, in an image input system according to the above aspect of the invention, it is possible to identify (select) an icon on the basis of triaxial three-dimensional position information, which includes the position information in the depth direction. With the depth information, advanced and dynamic icon identification can be achieved. In other words, it is possible to provide an image input system that utilizes a coordinate axis in the depth direction, which is unique to a three-dimensional image. To visually operate an icon displayed in three dimensions, a user reaches out their hand to a space where the target icon is displayed. By this means, it is possible to identify (select) the icon displayed thereat in the depth direction as desired. When the user reaches out the hand for the target icon toward the three-dimensional image, the most protruding part is the user's hand. A plurality of cameras picks up a plurality of images to detect the position of the hand in the depth direction. The captured images are analyzed to obtain three-dimensional position information as the detected position of the hand. The icon displayed at the position coinciding with the three-dimensional position information can be identified. Therefore, with the above aspect of the invention, it is possible to provide an image input system that utilizes a three-dimensional image. An image input system according to the above aspect of the invention offers an excellent user interface because it enables a user to select (identify) a desired icon by reaching out their hand for the icon displayed in three dimensions for “touch” operation. Therefore, it is possible to provide an image input system that is user friendly.

It is preferable that the plurality of icons should be arranged in such a manner that the icons do not overlap one another in a planar direction along a screen of the display device. It is preferable that, among the plurality of icons, a first function should be assigned to an icon, or a group of icons, that is relatively high in the depth direction and thus is displayed at a position that is relatively close to the user; a second function should be assigned to another icon, or another group of icons, that is lower in the depth direction than the icon or the group of icons mentioned first; and the second function is less frequently used than the first function. It is preferable that the plurality of icons should have an overlapping part in the planar direction along the screen of the display device; and, in addition, the icons should be disposed one over another as layers in the depth direction. It is preferable that a function that is assigned to the selected icon should be executed when a change in mode of the most protruding part at the user's side toward the three-dimensional image from a first mode to a second mode, which is different from the first mode, is detected.

It is preferable that the controller should cause the display device to display a cursor at a position based on the three-dimensional position information in the three-dimensional image. It is preferable that a color tone of the cursor or a shape of the cursor should change depending on the position in the depth direction. It is preferable that a plurality of the cursors should be displayed in the three-dimensional image. It is preferable that the selected icon should be displayed in a relatively highlighted manner in comparison with the other icons. It is preferable that the most protruding part at the user's side toward the three-dimensional image should be a hand of the user; and the mode of the hand, which includes the first mode and the second mode, should include spreading a palm of the hand, clenching a fist, and pointing a finger.

### BRIEF DESCRIPTION OF THE DRAWINGS

The invention will be described with reference to the accompanying drawings, wherein like numbers reference like elements.

FIG. 1 is a perspective view that schematically illustrates an example of the overall configuration of an image input system according to a first embodiment of the invention.

FIG. 2A is a perspective view that schematically illustrates, as an exemplary embodiment, a three-dimensional image displayed by a display device of the image input system.

FIG. 2B is a plan view of icons included in a 3D image.

FIG. 3 is a block diagram that schematically illustrates an example of the configuration of an image input system according to the first embodiment of the invention.

FIG. 4A is a side view of the icons illustrated in FIG. 2A.

FIG. 4B is a side view of the icons illustrated in FIG. 2A.

FIG. 5A is a diagram that illustrates another mode of displaying the icons in three dimensions.

FIG. 5B is a diagram that illustrates another mode of displaying the icons in three dimensions.

FIG. 6 is a perspective view that illustrates an example of a three-dimensional image displayed by an image input system according to a second embodiment of the invention.

FIG. 7 is a perspective view that schematically illustrates the overall configuration of an image input system according to a first variation example of the invention.

FIG. 8 is a perspective view that schematically illustrates an operation method according to a second variation example of the invention.

FIG. 9 is a perspective view that schematically illustrates the overall configuration of an image input system according to a third variation example of the invention.

### DESCRIPTION OF EXEMPLARY EMBODIMENTS

With reference to the accompanying drawings, exemplary embodiments of the present invention will now be explained in detail. In the accompanying drawings that will be referred to in the following description, different scales are used for layers/members illustrated therein so that each of the layers/members has a size that is easily recognizable.

### First Embodiment

### Overview of Image Input System

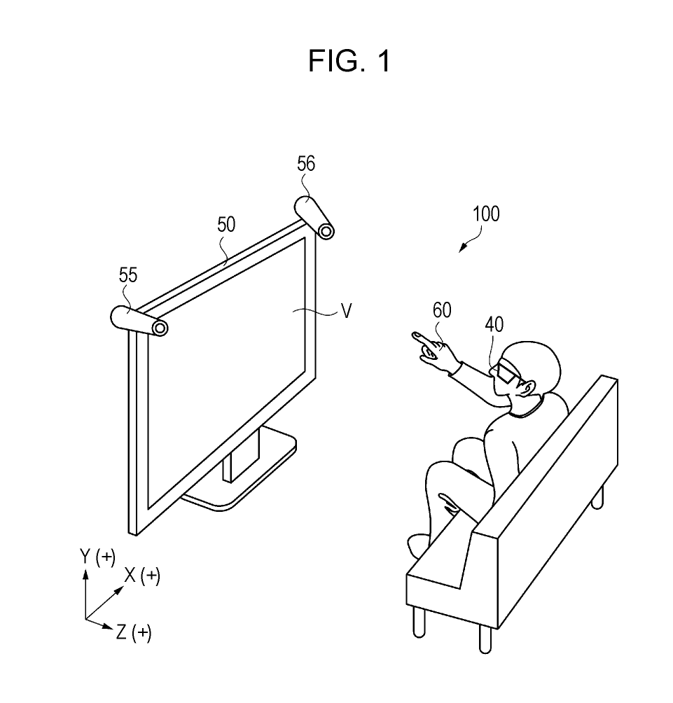

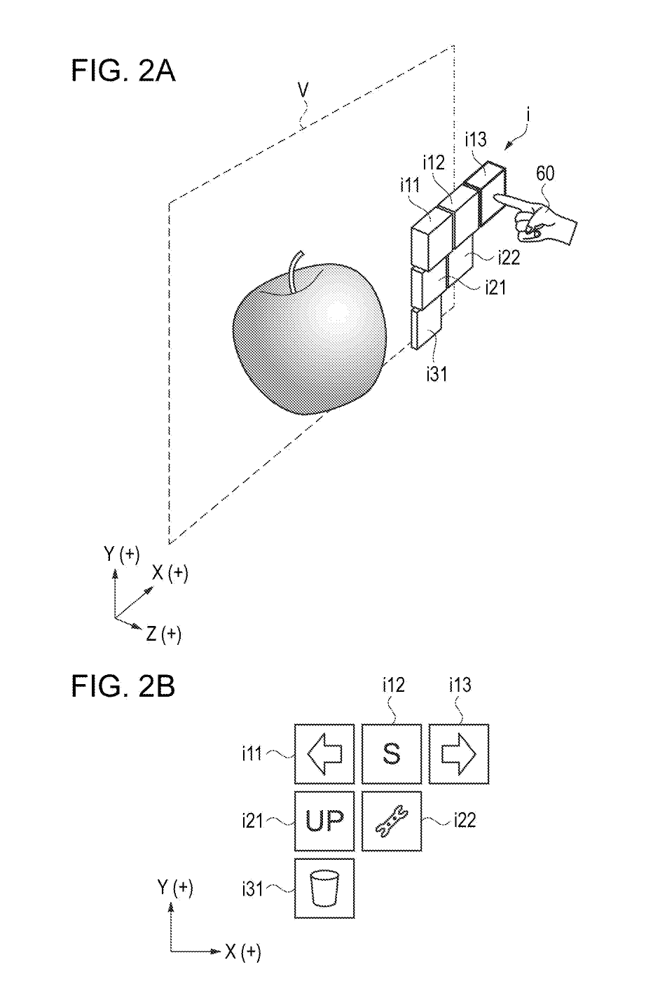

FIG. 1 is a perspective view that schematically illustrates an example of the overall configuration of an image input system according to a first embodiment of the invention. FIG. 2A is a perspective view that schematically illustrates, as an exemplary embodiment, a three-dimensional image displayed by a display device of the image input system. The overall configuration of an image input system 100 according to the present embodiment of the invention is explained first.

The image input system 100 includes a display device 50, cameras 55 and 56, and the like. The display device 50 is a large-sized plasma television. When used in combination with a pair of shutter glasses 40, which is included in accessories, the display device 50 can display a stereoscopic image (i.e., 3D image). Specifically, the display device 50 displays a left image and a right image alternately. In synchronization with the alternate switching, the left-eye lens of the shutter glasses 40 and the right-eye lens thereof are closed (i.e., put into a light shut-off state) alternately. A user who wears the shutter glasses 40 perceives the left image with the left eye and the right image with the right eye separately. The perceived left and right images are combined in the brain of the user. As a result, the brain of the user visually perceives a 3D image. In a precise sense, as described above, a 3D image is visually perceived in the brain of a user as a result of L/R image combination. However, to simplify explanation, the formation (i.e., recognition) of a 3D image in the brain of a user is hereinafter referred to as “displaying” of a 3D image.

The camera 55 is mounted at the upper left corner of the display device 50. The camera 56 is mounted at the upper right corner of the display device 50. The cameras 55 and 56 pick up images of a user who sits on, for example, a sofa opposite to the screen V of the display device 50 at different visual angles. In other words, the cameras 55 and 56 are mounted at positions where it is possible to pick up, at different visual angles, images of a user who sits at a position where the user faces a 3D image displayed by the display device 50. In each of the accompanying drawings including FIG. 1, the horizontal direction of the screen V of the display device 50, which has a horizontally long rectangular shape, is defined as the X direction. The vertical direction of the landscape screen V of the display device 50 is defined as the Y direction. A plain face that is substantially parallel to the screen V may be referred to as plane. The direction of a line perpendicular to the screen V is defined as the Z direction. The Z direction corresponds to the direction of the depth of a 3D image. The upward direction along the Y axis is defined as the Y(+) direction. The downward direction along the Y axis is defined as the Y(−) direction. The rightward direction along the X axis is defined as the X(+) direction. The leftward direction along the X axis is defined as the X(−) direction.

As illustrated in FIG. 2A, a 3D image displayed by the display device 50 includes a plurality of icons i for operation. The plurality of icons i is made up of icons of which positions in the depth direction (levels) in a 3D image are not the same. Specifically, as the plurality of icons i displayed to the right of an apple in the 3D image, icons are arranged in three rows. Three icons i11, i12, and i13 are displayed in the first row from the top. Two icons i21 and i22 are displayed in the second row. An icon i31 is displayed in the bottom row. The three icons i11, i12, and i13 in the first row from the top are the highest in the depth direction (i.e., the Z(+) direction). The two icons i21 and i22 in the second row are the second highest icons. The icon i31 in the bottom row is the lowest icon. Each of the icons i has the shape of a quadrangular prism. The prism has a substantially square face. The icons i have the same two-dimensional size. The thickness (i.e., height) of the prisms differs from one row to another.

The index finger of a hand 60 of a user is pointed at the icon i13. The finger-pointing illustration schematically represents a state in which the user is directly touching the icon i13 in a visual sense. It is illustrated therein that the user operates the icon i13 in the same way as done in the manual operation of a touch panel. In the image input system 100, image data is acquired as a result of imaging by means of the cameras 55 and 56 at different visual angles to detect the position of the index finger. The image data is subjected to image recognition processing and analysis processing to obtain 3D position information that contains position information in the depth direction. By this means, the image input system 100 can identify the icon i13 operated by the user. In other words, the position of the index finger is detected as the 3D position information on the basis of the image data. The image input system 100 can recognize that the icon i13, which is displayed at the position coinciding with the 3D position information, is selected out of the plurality of icons i displayed in 3D. That is, unlike a conventional input system that identifies an icon i on the basis of biaxial two-dimensional position information in a two-dimensional plane only, in the image input system 100 according to the present embodiment of the invention, it is possible to identify an icon i on the basis of triaxial three-dimensional position information, which includes the position information in the depth direction. In other words, the image input system 100 is a system that utilizes a coordinate axis in the depth direction (i.e., Z axis), which is unique to a 3D image.

It is illustrated in FIG. 2A that the icon i13, which is an icon in the top row that is the highest in the depth direction, is selected. It is possible for a user to select an icon i in another row, which has height in the depth direction different from that of the icon i13, by reaching out their hand to a position (i.e., space) at which the icon that they would like to operate visually is displayed. Similar to the foregoing case, the position of the index finger in a state in which the user has reached out their hand is detected as the 3D position information for selecting (i.e., identifying) the desired icon. The approach for the selection/operation of an icon is not limited to the stretching of a hand. The detection of any most protruding part at the user's side toward a 3D image (i.e., protruding in the Z(−) direction) suffices. For example, in place of a part of a body, a protruding object such as a thick pointer, a master-slave manipulator, or the like may be used. As illustrated in FIG. 2A, the selected icon i13 is displayed in a relatively highlighted manner in comparison with the other icons i. By this means, it is possible for a user to visually recognize that the icon i13 is currently selected. As an example of various highlighting methods, the display contrast of the icon that is currently selected may be set higher than that of the other icons. As another example, the thickness of the contour line of the selected icon may be increased. As still another example, the tone of color of the selected icon may be enhanced. Alternatively, the selected icon i may blink on and off for highlighted display.

In the present embodiment of the invention, for the purpose of explaining a preferred example, a so-called active display device (50) that includes a combination of a plasma TV and the pair of shutter glasses 40 is adopted as a 3D image display device. However, the 3D image display device is not limited thereto. Any display device that can display a 3D image in front of a user may be used as the 3D image display device. For example, it may be a so-called passive 3D image display device having the following features: the passive 3D image display device includes a display and a pair of light-polarizing glasses; a liquid crystal television to which polarization plates having polarizing axes different from each other are attached is used as the display; one of the polarization plates is provided on odd scanning lines (left image) on the screen of the liquid crystal television; the other of the polarization plates is provided on even scanning lines (right image) on the screen of the liquid crystal television; the pair of polarizing glasses has a polarization plate that has a polarizing axis parallel to that of the odd lines on its left-eye lens and a polarization plate that has a polarizing axis parallel to that of the even lines on its right-eye lens. Alternatively, a parallax barrier or a lenticular lens for L/R image separation may be provided on the front face of a display without using any dedicated pair of glasses. A display device having such a configuration enables a user to view a 3D image with the naked eye at a proper viewing position.

### Circuit Block Configuration of Image Input System

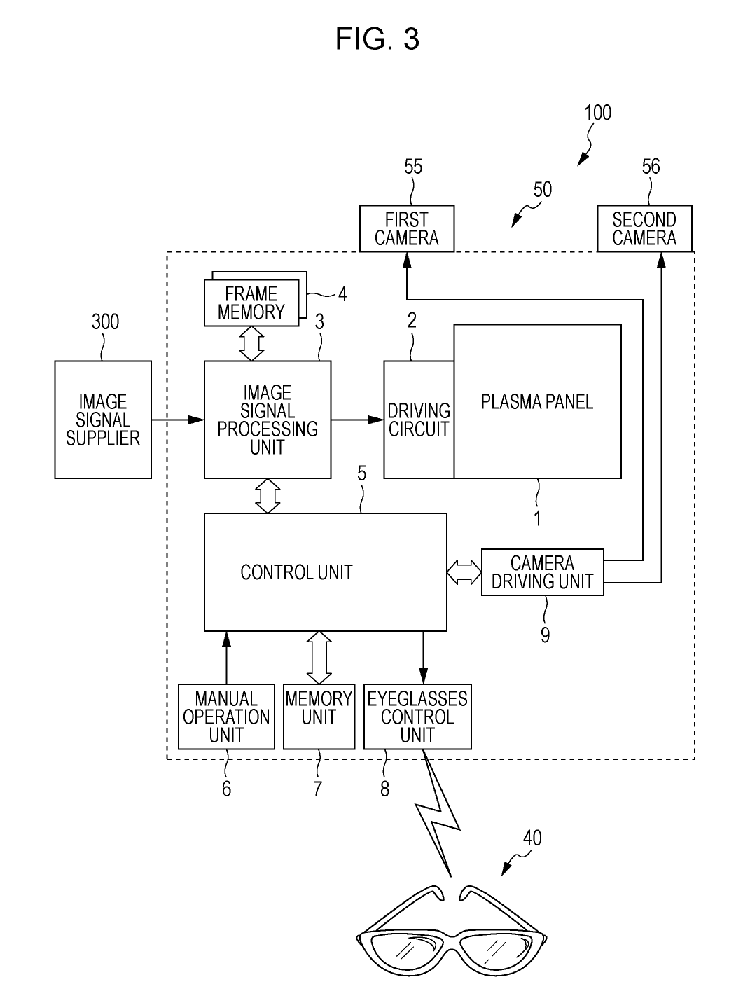

Next, the configuration of the image input system 100 for offering input interface described above is explained with a focus on the configuration of the display device 50. FIG. 3 is a block diagram that schematically illustrates an example of the configuration of an image input system according to an exemplary embodiment of the invention. The display device 50 includes a plasma panel 1, a driving circuit 2, an image signal processing unit 3, a control unit 5, an eyeglasses control unit 8, a camera driving unit 9, and the like. The plasma panel 1 is a plasma display panel. As a preferred example, the diagonal size of the plasma panel 1 is fifty inches or greater. The plasma panel 1 preferably has resolution corresponding to the picture quality of a high-definition television (1,280×720). The driving circuit 2 is a circuit for driving the plasma panel 1 for scanning operation. The driving circuit 2 includes a scanning line (row electrode) driving circuit, a data line (column electrode) driving circuit, and the like.

The image signal processing unit 3 is a processor that converts image data inputted from an image signal supplier 300, which is, for example, an external device, into an image signal having a proper format and the like for display on the plasma panel 1. A frame memory 4 is connected to the image signal processing unit 3 as its separate memory. The frame memory 4 has capacity for storing left image data and right image data for a plurality of frames. The image signal supplier 300 is, for example, a Website from which moving pictures are distributed via the Internet, a Blu-ray disc player (registered trademark), or a personal computer. A 3D image signal that conforms to a 3D video format such as Side-by-Side, which is a format in which a left image and a right image are transmitted side by side, or the like is inputted from the image signal supplier 300 into the image signal processing unit 3. In accordance with a control signal supplied from the control unit 5, the image signal processing unit 3 uses the frame memory 4 to perform scaling processing on the inputted 3D image signal. The scaling processing includes data complementation, decimation, clipping, and the like. The image signal processing unit 3 outputs image data adjusted for the resolution of the plasma panel 1. In addition, the image signal processing unit 3 performs OSD (On-Screen Display) processing for displaying icons i on the generated image data. Specifically, the image signal processing unit 3 performs image processing for superposing icons i stored in a memory unit 7 on the generated image data.

The control unit 5 is a CPU (Central Processing Unit) that controls the operation of system components. A manual operation unit 6, the memory unit 7, and a timer unit (not illustrated in the drawing) are connected to the control unit 5. The control unit 5 functions also as an analyzing unit that performs, by using the memory unit 7 and the image signal processing unit 3 including the frame memory 4 connected thereto, image recognition processing and analysis processing on image data acquired as a result of imaging by the cameras 55 and 56, thereby obtaining and outputting analysis information that contains 3D position information. The analysis information contains time information outputted from the timer unit such as a real time clock or the like. The reason why the analysis information contains the time information is that it is necessary to analyze two image data at the same imaging time in order to analyze 3D position information because the mode of a hand in motion of a user could change as time passes. The manual operation unit 6 is provided at a lower frame area under the screen V of the display device 50. The manual operation unit 6 includes a plurality of manual operation buttons (not shown). The plurality of manual operation buttons includes a button(s) for dedicated use, for example, a power button, and a plurality of other buttons for general selection/determination use, for example, a button for switching between a 2D image and a 3D image, a button for selecting the type of icons displayed, and the like. A remote controller (not shown) that is provided with a plurality of manual operation buttons that are the same as or similar to the above buttons is included in the accessories of the image input system 100.

The memory unit 7 is a non-volatile memory such as, for example, a flash memory. Various programs for controlling the operation of the display device 50 including an input operation detection program and accompanying data are stored in the memory unit 7. The input operation detection program is a program in which the sequence and content of the following procedures is written: after the imaging operation of the cameras 55 and 56, the position of an index finger is detected as 3D position information on the basis of image data acquired by the cameras 55 and 56; then, an icon i that is displayed at the position coinciding with the 3D position information is selected out of a plurality of icons i displayed in 3D. The programs include an image analysis program for causing the control unit 5 to function also as the analyzing unit and a program for controlling the operation of the pair of shutter glasses 40. Besides the memory unit 7, the image input system 100 may further include a mass storage hard disk drive.

The eyeglasses control unit 8 includes a wireless communication unit (not shown). In accordance with the shutter-glasses controlling program mentioned above, the eyeglasses control unit 8 transmits a control signal to the pair of shutter glasses 40. A liquid crystal shutter is provided on each of the left-eye lens and the right-eye lens of the pair of shutter glasses 40. In accordance with the control signal supplied from the eyeglasses control unit 8, each of the left-eye piece (i.e., L lens piece) and the right-eye piece (i.e., R lens piece) of the pair of shutter glasses 40 is exclusively switched between a light transmissive state and a light shut-off state. In other words, in synchronization with the alternate display of a left image and a right image, the left-eye piece and the right-eye piece are switched alternately between the light transmissive state and the light shut-off state. In a preferred example, the left image and the right image are displayed on the screen V at a rate of 120 frames per second. The pair of shutter glasses 40 performs shuttering operation for alternate visual transmission to the left eye and the right eye each at a rate of 60 frames per second. In other words, the left eye and the right eye selectively perceive the left image and the right image respectively at the rate of 60 frames per second. As a result, a 3D image is recognized in the brain of the user. Though not illustrated in the drawing, the pair of shutter glasses 40 includes built-in components such as a power unit including a lithium-ion battery and the like, a wireless communication unit that receives the control signal, a driving circuit that drives the left-eye liquid crystal shutter and the right-eye liquid crystal shutter, and the like.

In accordance with a control signal supplied from the control unit 5, the camera driving unit 9 controls the operation of the cameras 55 and 56. The controllable functions of the cameras 55 and 56 include imaging, telescoping, wide-angle switchover, focusing, and the like. As a preferred example, a camera that is provided with a CCD (Charge Coupled Device) as its image pickup device is used for each of the cameras 55 and 56. Preferably, each of the cameras 55 and 56 should be provided with a lens having a function of telescoping and wide-angle switchover. Each of the cameras 55 and 56 is not limited to a CCD camera. For example, a CMOS (Complementary Metal Oxide Semiconductor) image sensor or a MOS image sensor may be used as the image pickup device of the camera 55, 56. The sampling rate of imaging operation may be set at any rate at which it is possible to detect a change in the motion of a user. For example, when a still image is picked up, the sampling rate is set at a rate of twice, three times, or four times per second. Alternatively, a moving image may always be picked up during the running of the input operation detection program to extract a still image out of the moving image for image analysis.

### Initial Setting and Details of Icons

Referring back to FIG. 2A, initial setting is explained below. For example, a personal computer is connected as the image signal supplier 300 to the image signal processing unit 3. FIG. 2A illustrates a state in which a still image (i.e., stereoscopic photograph) memorized in the personal computer is displayed on the screen V by means of image reconstruction software. Since the input operation detection program is resident in the image reconstruction software as has been set by a user with the manual operation unit, the plurality of icons i for operation is displayed. Prior to actual input operation, a position where a user sits, the size of a 3D image, and the like have been pre-adjusted to ensure that the stretched position of a hand of the user should substantially coincide with the positions of the icons i in the 3D image. In other words, the position where the user sits, the size of the 3D image, and the like are calibrated as initial setting to ensure that the plurality of icons i should be displayed at the position of the reached hand of the user. The icons i are arranged in such a manner that they do not overlap one another in the direction of a plane along the screen V.

FIG. 2B is a plan view of icons included in a 3D image. As illustrated in FIG. 2B, an operating function is assigned to each of the icons of which positions in the depth direction (i.e., heights) in the 3D image are not the same. In the first row from the top, which is the highest in the depth direction, a “Back” function is assigned to the icon i11. The back function is a function for displaying the last image. In the highest top row, a “Slide Show” function is assigned to the icon i12. The slide show function is a function for sequentially displaying all images in the folder in which the still image is contained. In the highest top row, a “Next” function is assigned to the icon i13. The next function is a function for displaying the next image. A “Select Folder” function is assigned to the icon i21 in the center row. The folder selection function is a function for accessing a folder that is located in the layer immediately above the current layer in a tree. A “Change Setting” function is assigned to the icon i22 in the center row. The setting change function is a function for changing settings such as, for example, the color tone, size, and aspect ratio of the 3D image. In the bottom row, which is the lowest in the depth direction, an “Erase” function for erasing the image data that is now being displayed (apple) is assigned to the icon i31.

From the viewpoint of easiness in operation, it is relatively easy to operate the icons including the icon i11 in the first row from the top, which is the highest in the depth direction. This is because the row to which the icon i11 belongs is the closest to the user, which means that the distance by which the user has to reach out their hand for the icon is the shortest, resulting in relatively easy operation. It is relatively hard to operate the icon i31 in the bottom row, which is the lowest in the depth direction. This is because the row of the icon i31 is the remotest from the user, which means that the distance by which the user has to reach out their hand for the icon is the longest, resulting in relatively hard operation. By determining the arrangement of the plurality of icons i depending on frequency in use or functions, it is possible to set different levels of easiness in operation for the icons i. For example, in FIG. 2, “Back”, “Slide Show”, and “Next”, which are the most frequently used functions of the image reconstruction software, are assigned to the row to which the icon i11 belongs, that is, the first row from the top. “Select Folder” and “Change Setting”, which are less frequently used, are assigned to the row to which the icon i21 belongs, that is, the center row. To help avoid accidental erasure due to an operation mistake, “Erase” is assigned to the row of the icon i31, which is the least easy to be operated. When attention is focused on the row to which the icon i11 belongs and the row to which the icon i21 belongs, “Back”, “Slide Show”, and “Next” correspond to a first function; “Select Folder” and “Change Setting” correspond to a second function. When attention is focused on the row to which the icon i21 belongs and the row of the icon i31, “Select Folder” and “Change Setting” correspond to the first function; “Erase” corresponds to the second function.

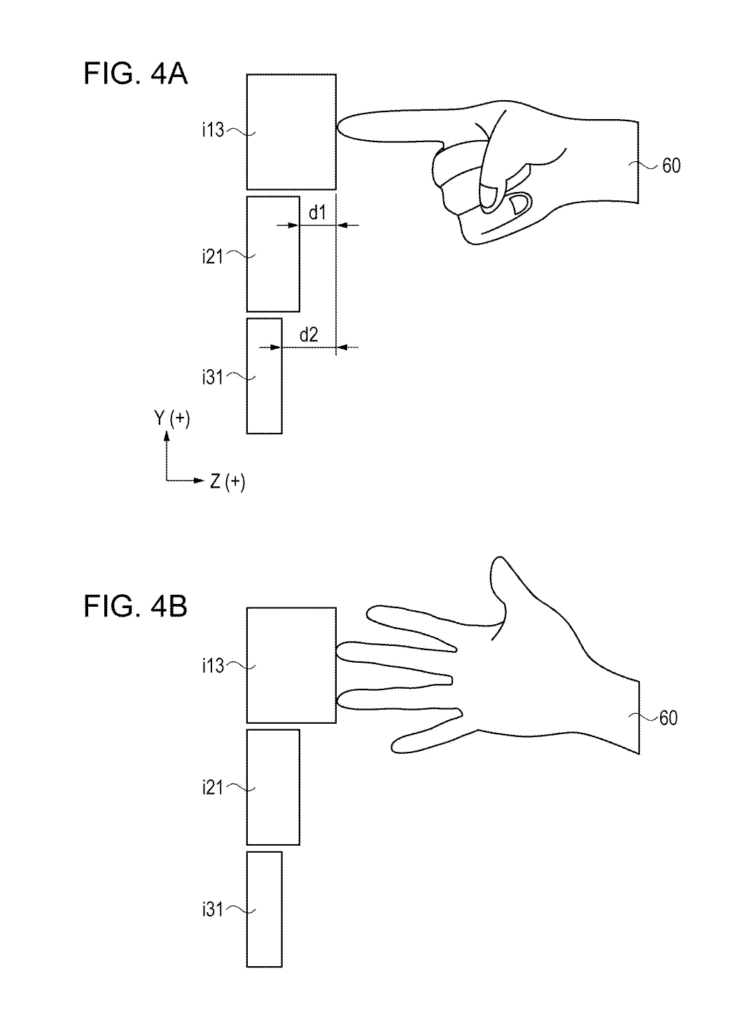

Each of FIGS. 4A and 4B is a side view of the icons illustrated in FIG. 2A. As explained earlier, the height in the depth direction of the plurality of icons i differs from one row to another. The row to which the icon i21 belongs, that is, the center row, is lower than the row to which the icon i11 belongs, that is, the first row from the top, by a difference in height (hereinafter referred to as “depth-difference value”) d1. The row of the icon i31 is lower than the row to which the icon i11 belongs by the depth-difference value d2. The depth-difference value d2 is larger than the depth-difference value d1. Depending on display environment including, for example, the size of the 3D image and the distance to the user, the height of each row may be set arbitrarily within a range in which the icon can be identified in the depth direction. FIGS. 2A and 4A show a state in which the icon i13 is identified as the icon selected out of the plurality of icons i. However, the “Next” function, which is assigned to the icon i13, is not actually executed merely by selecting the icon i13. To actually execute the selected function, it is necessary to further detect a specific motion that is associated with the enabling of the selection (i.e., execution).

FIG. 4B illustrates an example of a motion for actually executing the function. In the illustrated example, the user spreads the palm of the hand 60 at the position where the icon i13 is selected as in “paper” of rock-paper-scissors hand game. Upon the detection of the spreading of the palm of the user's hand 60, the “Next” function, which is assigned to the icon i13, is actually executed. As a result, the next 3D image such as, for example, an orange (not shown) is displayed. In the illustrated example, a mode in which the index finger is pointed at the icon i13 as shown in FIG. 4A corresponds to a first mode. A mode in which the palm is spread as shown in FIG. 4B corresponds to a second mode. That is, a change in the mode (gesturing form) of the most protruding part at the user's side toward the 3D image is recognized as an instruction for operation; the function indicated by the motion is actually executed upon the detection of the change. In other words, a pre-defined change in the form (pattern) of the hand 60 is recognized as an instruction for operation; the function assigned to the pattern is actually executed. The change in the form (mode) is not limited to the spreading of the palm of a hand. Any motion that enables a change from the initial mode shown in FIG. 4A to be detected in image analysis may be pre-defined. For example, instead of spreading the palm of the hand 60, the index finger or any other finger may be waved from side to side slowly while remaining held up in a pointing manner. As another example, a fist may be clenched for actually executing the function.

### Cursor Display

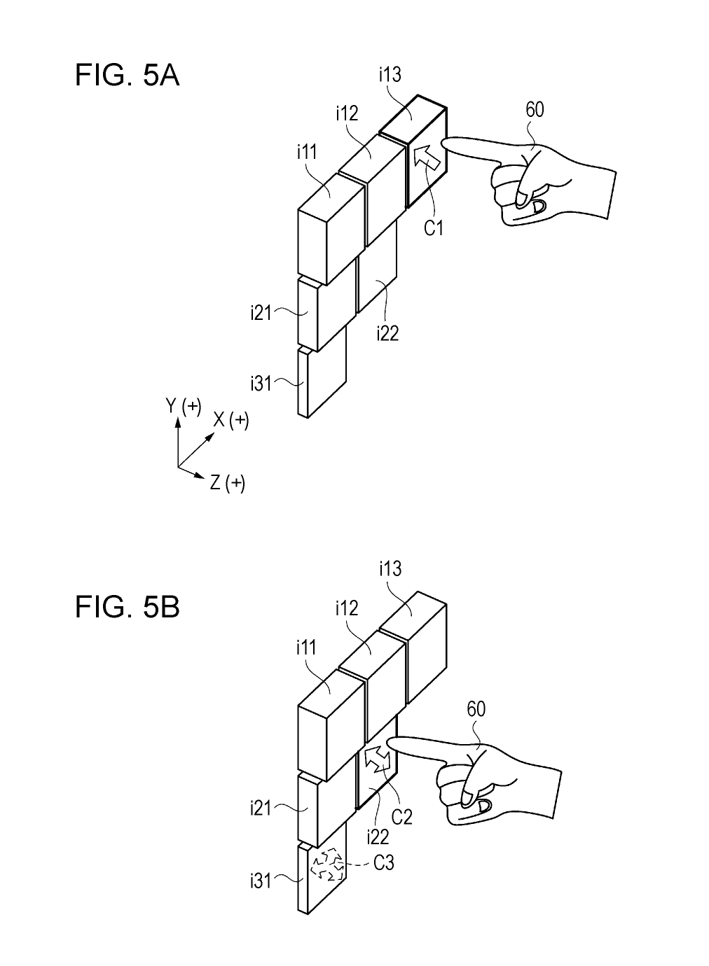

Each of FIGS. 5A and 5B is a diagram that illustrates another mode of displaying 3D icons. Each of the icon display modes corresponds to the icon display mode illustrated in FIG. 2. As explained earlier while referring to FIG. 2A, since the selected icon i is displayed in a highlighted manner, it is visually conspicuous among the plurality of icons i. To further highlight the selected icon i, a cursor may be displayed on it additionally. In FIG. 5A, a cursor c1 shown by a single-headed arrow is displayed on the selected icon i13. The cursor c1 is displayed at a place determined based on (coinciding with) 3D information on the position of the hand 60 (approximately the tip of the index finger) detected as a result of image recognition. Except for the displaying of the cursor on the selected icon, the mode of display in FIG. 5A is the same as that of FIG. 2A. In a preferred example, when the icon i22 in the center row is selected as illustrated in FIG. 5B, the shape of a cursor changes from the single-headed arrow c1 into a double-headed arrow c2. When the icon i31 in the bottom row is selected, the shape of a cursor changes from the double-headed arrow c2 into a triple-headed arrow c3. That is, the shape of a cursor changes depending on the position of the selected icon in the depth direction. The shape of a cursor is not limited to an arrow. It may have any shape that makes it easier for the selected icon i to be identified. For example, the shape of a cursor may be a circle, a triangle, a quadrangle, or a combination of them.

The highlighting method is not limited to the changing of the shape of a cursor. Any method that makes it easier for the selected icon i to be identified may be used. Alternatively, the mode of display may be changed as in the following examples. The color tone of the selected icon may be changed. The degree of enhancement of the contour line thereof may be changed. The icons in the rows other than the top row may blink on and off with a blinking speed for a lower row in the depth direction being set at a higher speed. The above alternative methods may be combined. In the present embodiment of the invention, the total number of the icons is six. The icons are arranged in three levels in the depth direction. However, the total number of icons and the number of levels is not limited to the above example. It may be set arbitrarily depending on display environment setting (specification) such as the size of a 3D image, display content, and the like.

As explained above, an image input system according to the present embodiment of the invention offers the following advantages. The plurality of icons i displayed in a 3D image is made up of icons of which positions in the depth direction (levels) in the 3D image are not the same. Each icon can be identified from the other icons by using 3D position information that contains information on its position in the depth direction. That is, unlike a conventional input system that identifies an icon i on the basis of biaxial two-dimensional position information in a two-dimensional plane only, in the image input system 100 according to the present embodiment of the invention, it is possible to identify (select) an icon i on the basis of triaxial three-dimensional position information, which includes the position information in the depth direction. With the depth information, advanced and dynamic icon identification can be achieved. In other words, it is possible to provide an image input system that utilizes a coordinate axis in the depth direction, which is unique to a 3D image.

To visually operate an icon i displayed in 3D, a user reaches out the hand 60 to a space where the target icon i is displayed. By this means, it is possible to identify (select) the icon i displayed thereat in the depth direction as desired. When the user reaches out the hand 60 for the target icon i toward the 3D image, the most protruding part is the user's hand 60. A plurality of cameras picks up a plurality of images to detect the position of the hand 60 in the depth direction. The captured images are analyzed to obtain 3D position information as the detected position of the hand 60. The icon i displayed at the position coinciding with the 3D position information can be identified. Therefore, with the present embodiment of the invention, it is possible to provide the image input system 100, which utilizes a 3D image. The image input system 100 offers an excellent user interface because it enables a user to select (identify) a desired icon i by reaching out their hand for the icon i displayed in 3D for “touch” operation. Therefore, the image input system 100 is user friendly.

Upon the detection of the spreading of the palm of the user's hand 60 at the position where the icon i13 is selected, the “Next” function, which is assigned to the icon i13, is actually executed. That is, a change in the mode (form) of the most protruding part at the user's side toward the 3D image is recognized as an instruction for operation; the function indicated by the motion is actually executed upon the detection of the change. In other words, a pre-defined change in the form (pattern) of the hand 60 is recognized as an instruction for operation; the function assigned to the pattern is actually executed. Therefore, the image input system 100 makes it possible to perform input operation easily. In addition, since the selected icon i is displayed in a highlighted manner, it is visually conspicuous among the plurality of icons i. Therefore, it is easy for a user to recognize that the icon is in a selected state. Moreover, since the cursor c1 is displayed at the position of the hand 60 (the tip of the index finger) detected as a result of image recognition, the user can recognize that the icon is in a selected state more easily. Furthermore, since the shape of a cursor, the color tone thereof, or the like changes depending on the position in the depth direction, it is possible to easily recognize the selected position in the depth direction. Therefore, the image input system 100 can visualize the state of input operation. In other words, a user can recognize the state of input operation intuitively.

Regarding the assignment of a plurality of functions to a plurality of icons, “Back”, “Slide Show”, and “Next”, which are the most frequently used functions, are assigned to the row to which the icon i11 belongs. “Select Folder” and “Change Setting”, which are less frequently used, are assigned to the row to which the icon i21 belongs. “Erase” is assigned to the row of the icon i31. That is, functions that are more frequently used are assigned to icons that are closer to a user. Functions that are less frequently used are assigned to icons that are more distant from the user. By determining the arrangement of the plurality of icons i in consideration of frequency in use, it is possible to make operation easier. A function(s) that is difficult to be redone after execution or should not be used inadvertently, for example, an “Erase” function, is assigned to an icon(s) that is most distant from the user (i.e., the lowest icon in the depth direction). By this means, it is possible to provide the image input system 100 that features excellent function-icon assignment.

### Second Embodiment

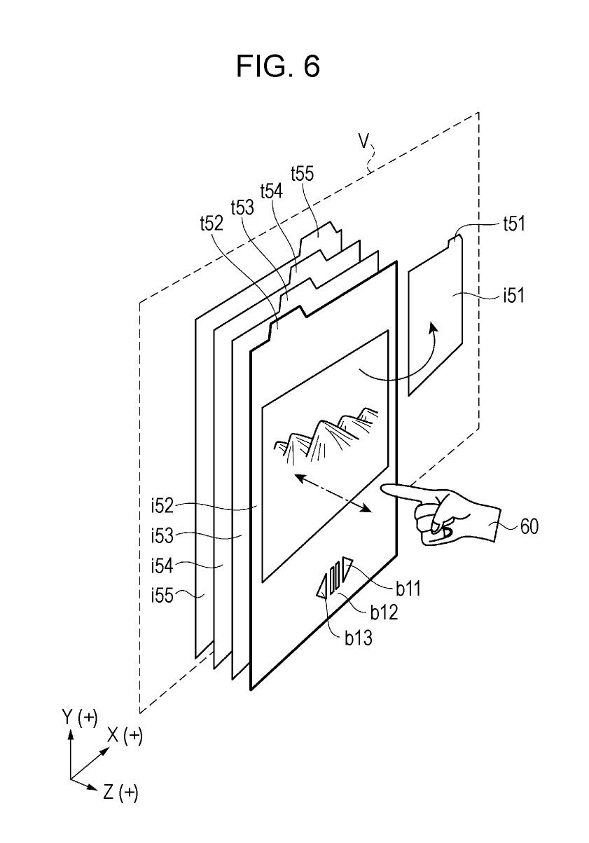

FIG. 6 is a perspective view that illustrates an example of a 3D image displayed by an image input system according to a second embodiment of the invention. FIG. 6 corresponds to FIG. 2A. An image input system according to the second embodiment of the invention is explained below. The same reference numerals are used for the same components as those of the first embodiment of the invention. The explanation of these components is not repeated here. The configuration of an image input system according to the present embodiment of the invention is the same as that of the image input system 100 according to the first embodiment of the invention. The difference between the present embodiment and the first embodiment lies in a plurality of icons displayed in 3D. Except for the above difference, the same explanation as that of the first embodiment holds true.

A 3D image displayed by the display device 50 includes a plurality of icons i52, i53, i54, and i55. As illustrated in FIG. 6, the plurality of icons i52 to i55 is displayed in 3D layers in the depth direction. The icon i52 is displayed as the forefront icon in the illustrated 3D image. Since the front is defined as the positive Z-axis side, the icon i52 is displayed as the first icon from the front. The icon 52 is a composite icon that has a function of a file folder and another function of application software for executing files saved in the file folder. Each of the plurality of icons i52 to i55 has the shape of a flat sheet with almost no thickness (height). In a plan view, it has the shape of a vertically long rectangle. The still image of row of mountains that constitutes the starting image of moving picture stored therein is displayed in thumbnail on the icon i52. Operation icons b11, b12, and b13 for playing back, pausing, and winding back the moving-picture file are displayed under the thumbnail. The application software is not limited to moving-image file playback software. It may be any software that can execute the stored file.

The icons i53, i54, and i55 are displayed in layers behind the icon i52, that is, at the negative Z-axis side, in this sequential order at equal interlayer spaces. Each of the icons i53, i54, and i55 has features that are the same as or similar to those of the icon i52. That is, in the direction of the depth of the 3D image, the icon i55 is displayed as the hindmost icon at the lowest layer level. The icon i54 is displayed over the icon i55. The icon i53 is displayed over the icon i54. The icon i52 is displayed over the icon i53. In other words, the icons i53, i54, and i55 are sequentially disposed in layers behind the icon i52, which is displayed at a position that is the closest to a user.

The user can select an icon out of a plurality of icons i by reaching out the hand 60 for the icon as explained in the first embodiment of the invention. In FIG. 6, since the position of the tip of the index finger of the hand 60 substantially coincides with the position of the icon i52, the icon i52 is displayed in a highlighted manner to indicate its selected state. In the present embodiment of the invention, the icons have substantially the same two-dimensional size. In addition, the icons overlap one another at almost the entire area thereof. Therefore, the icon i is actually selected only on the basis of the position of the hand 60 in the depth direction as shown by a dashed-dotted arrow. In other words, when the hand 60 overlaps the icons in a plan view, the target icon i can be identified (selected) only on the basis of information on the position of the hand 60 in the depth direction in the analyzed 3D position information.

In FIG. 6, which shows a state in which the icon i52 is currently selected, the icon i52 is displayed as the first icon from the front. In the default state prior to the selection of the icon i52, an icon i51 was displayed as the first icon from the front. At a point in time at which the hand 60 reaches the layer level of the icon i52, the icon i51 moves from the front position to the right of the icon i52 and is displayed thereat in a reversed state with reduction in size as shown by a solid-curved arrow in the drawing. Upon the returning of the position of the hand 60 to the default level of the icon i51, the icon i51 that is in a reduced display state is selected. As a result, the icon i51 is displayed as the first icon from the front, which is its default display position. The display behavior of other icons is the same as above. That is, except for the default state, the icon that is currently selected is displayed as the first icon from the front. The icon(s) that was displayed in front of the selected icon before the selection, if any, is displayed next to the selected icon in a reversed state with reduction in size.

The icons i have tabs t51, t52, t53, t54, and t55, respectively. The tabs t51 to t55 do not overlap one another in a plan view. Therefore, even though the icons i have the same two-dimensional size, it is possible for a user to visually perceive the presence of lower-layer icons behind the forefront icon. The means for enabling a user to visually perceive the presence of a plurality of icons laid one over another is not limited to the tabs. For example, a plurality of icons may be laid one over another not at the same two-dimensional position but with a slight shift. That is, the layered arrangement of the plurality of icons i may be modified as long as the following conditions are satisfied: the icons have an overlapping part in a planar direction; and, in addition, the icons i are disposed one over another as layers in the depth direction. A cursor may be displayed at the position of the hand 60 (the tip of the index finger) detected as a result of image recognition as in the first embodiment of the invention.

In the present embodiment of the invention, there are two methods for actually executing the function assigned to the selected icon (for enabling the selection). One of the two methods is to change the mode (form, pattern) of the hand 60 at the selected position. The function executed when the mode of the hand 60 is changed at the selected position is “Playback”, which is the same function as that of the operation icon b11. The other method is to move the hand 60 to the position of the operation icon b11, b12, b13 displayed on the selected icon. When the icon is put into a selected state, the functions of the operation icons b11, b12, and b13 of the selected icon are enabled. Therefore, a user can execute a desired function merely by moving the hand 60 to the position of the corresponding operation icon b11, b12, b13. As a modification example, the function may be executed when, after the moving of the hand 60 to the position of the corresponding operation icon b11, b12, b13, it remains stationary for two seconds or longer. In the illustrated example of FIG. 6, when the “Playback” function of the operation icon b11 is executed, the moving picture of the row of mountains stored in the icon i52 is displayed on the screen V as full-screen 3D video.

As explained above, besides the advantages of the first embodiment of the invention, an image input system according to the present embodiment of the invention offers the following advantages. For a display mode in which icons are disposed one over another as layers in the depth direction, it is possible to identify (select) a desired icon on the basis of 3D position information that contains position information in the depth direction. A user can select an icon by moving the hand 60 in the depth direction. The icon that is currently selected is displayed as the first icon from the front. Therefore, it is possible to find a desired icon (file) quickly. Therefore, it is possible to provide an image input system that offers an excellent user interface and thus is user friendly.

Each of the plurality of icons i has a tab. Alternatively, the icons i are laid one over another not at the same two-dimensional position but with a slight shift. That is, the icons i have an overlapping part in a planar direction; and, in addition, the icons i are disposed one over another as layers in the depth direction. Because of the identification tabs or the shift in 2D positions, even though the icons i constitute 3D layers, it is possible for a user to visually perceive the presence of the lower-layer icons behind the forefront icon. Therefore, it is possible to provide an image input system that is user friendly.

The scope of the invention is not limited to the exemplary embodiments described above. The invention may be modified, adapted, changed, or improved in a variety of modes in its actual implementation. Variation examples are explained below.

### Variation Example 1

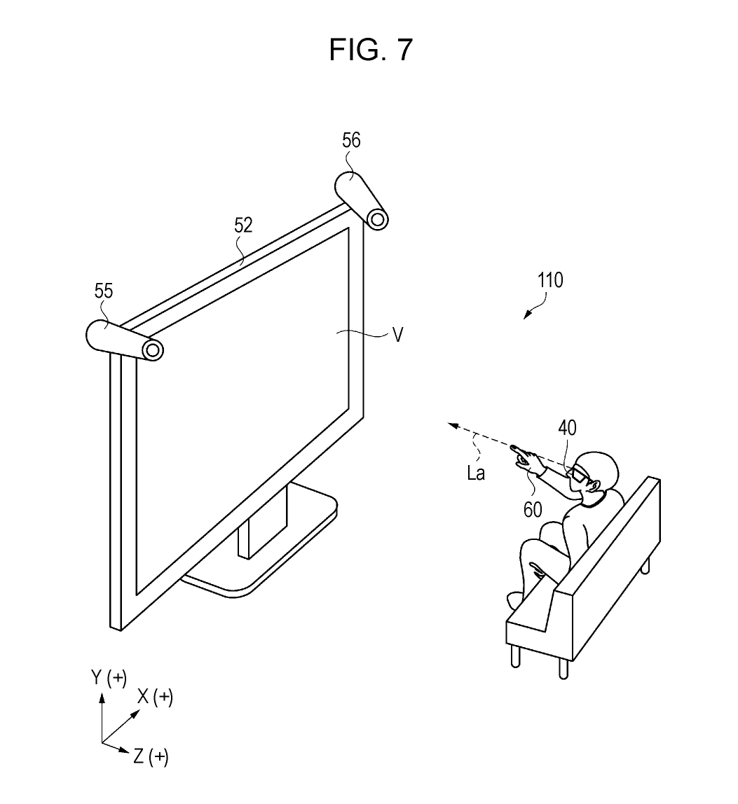

FIG. 7 is a perspective view that schematically illustrates the overall configuration of an image input system according to a first variation example of the invention. FIG. 7 corresponds to FIG. 1. In the foregoing embodiments of the invention, it is explained that a user reaches out a hand for a 3D icon for operation as if the user were directly touching the icon. However, in a case where the distance between a screen and the user is large, the icon is pointed from a distance. In such a case, it is necessary to make up for a decrease in pointing precision so that the icon that the user would like to select can be identified properly. The present variation example discloses a compensating method for precise identification. An image input system 110 according to the first variation example of the invention is provided with a display device 52 that has a large display screen V. The diagonal size of the screen V is one hundred inches or greater. Therefore, the distance between the screen V and the user in the present variation example is larger than that of the example illustrated in FIG. 1. Except for the above difference, the image input system 110 according to the first variation example of the invention is the same as the image input system 100 according to the first embodiment of the invention.

In the present variation example, a user points at an icon that is displayed at a comparatively distant position. Therefore, in the image input system 110, it is assumed for icon identification (icon selection) that the icon that the user would like to select lies on an extension line of a line segment La that connects the center, to be exact, substantially the center, of the head of the user and the hand 60. It is possible to detect the center of the head of the user by performing image analysis processing on image data acquired as a result of imaging by the cameras 55 and 56 as done for the hand 60. In a case where the size of the screen V is larger than that of the present variation example and thus a user sits at a more distant position, an end point of the line segment La may be changed to a position that enables the icon that the user would like to select to be identified more efficiently. For example, an end point of the line segment La may be set at substantially the center of the body of the user. With the above compensating method, even in a case where the distance between a screen and a user is large, it is possible to properly identify an icon that the user would like to select.

### Variation Example 2

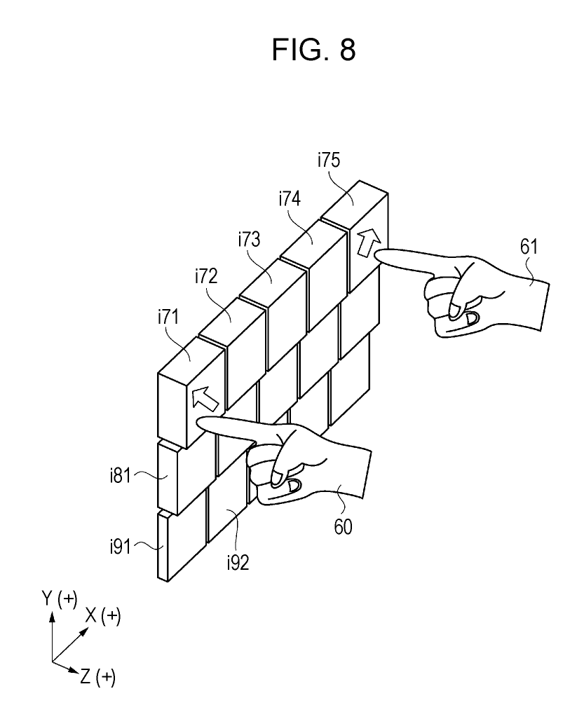

FIG. 8 is a perspective view that schematically illustrates an operation method according to a second variation example of the invention. FIG. 8 corresponds to FIG. 2A. In the foregoing embodiments of the invention, it is explained that operation is performed with a single hand (cursor). However, the scope of the invention is not limited to such an operation method. For example, a plurality of hands (cursors) may be used for simultaneous operation. FIG. 8 shows, in a perspective view, an example of a plurality of icons displayed in 3D according to the second variation example of the invention. In the illustrated example, the icons i are arranged in three rows. Five icons i71, i72, i73, i74, and i75 are displayed in the first row from the top. Five icons constituting the center row, which is the row to which an icon i81 belongs, are displayed under the icons i71 to i75. Five icons constituting the bottom row, which is the row to which an icon i91 belongs, are displayed under the icons in the center row. The icons i71 to i75 in the first row from the top are the highest in the depth direction (i.e., the Z(+) direction). The icons including the icon i81 in the center row are the second highest group of icons. The icons including the icon i91 in the bottom row are the lowest group of icons.

In the illustrated example of FIG. 8, two users operate the icons. One of the two users is about to select the icon i71 with the hand 60. The other user is about to select the icon i75 with a hand 61. Therefore, cursors are displayed at the positions of the hands 60 and 61. If operation application can accept two inputs at the same time as in a video game, it is possible to select the two icons i71 and i75 concurrently. If the application requires processing in time series, for example, the icon “touched” first is selected in accordance with time-measured data in analysis information. The respective positions of the two hands 60 and 61 can be detected by performing image recognition processing and analysis processing on image data acquired as a result of imaging by two cameras. The order of priority in processing may be determined on the basis of the positions of icons in the depth direction. For example, if the hands 60 and 61 are respectively detected at the positions of the selected icons i81 and i75 at the same time, the icon i75, which is higher in the depth direction, is selected first. With the method according to the present variation example of the invention, operation can be performed with both hands or by a plurality of users. Therefore, the image input system can be used for various applications.

### Variation Example 3

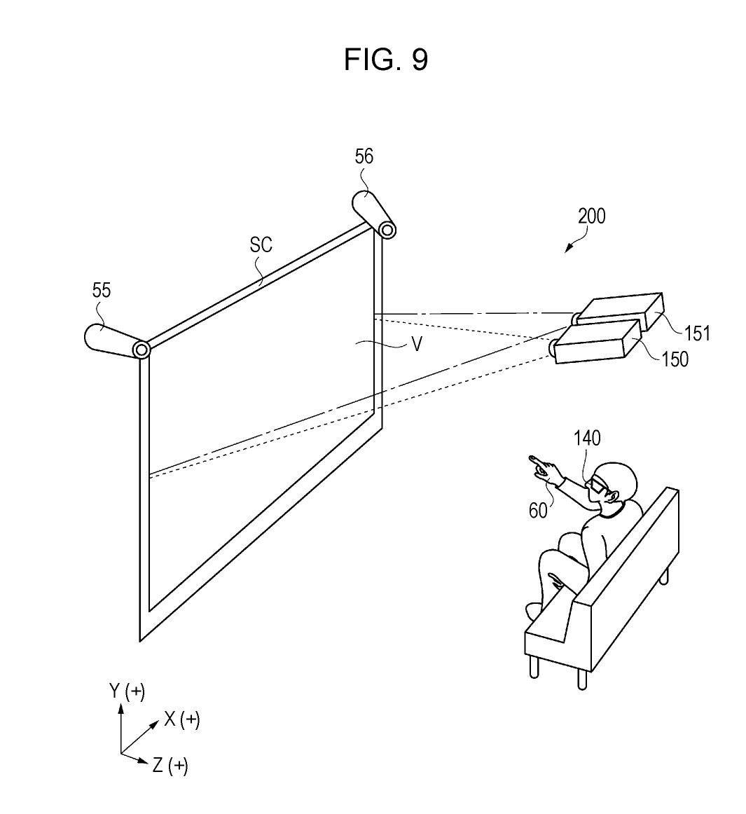

FIG. 9 is a perspective view that schematically illustrates the overall configuration of an image input system according to a third variation example of the invention. FIG. 9 corresponds to FIG. 1. In the foregoing embodiments of the invention, it is explained that an image input system includes, as its display device, an integral-type display device such as a plasma television, a liquid crystal television, or the like. However, the scope of the invention is not limited to such an exemplary configuration. For example, a projection-type display device may be used as a substitute for the integral-type display device. An image input system 200 according to the third variation example of the invention includes a host projector 150, a slave projector 151, the cameras 55 and 56, a pair of light-polarizing glasses 140, and the like. The host projector 150 serves also as a controller that controls the slave projector 151 and the cameras 55 and 56. Besides a projection unit that projects an image, the host projector 150 includes circuitry that has the same functions as those of the control unit 5, the image signal processing unit 3, the camera driving unit 9, and the like, which are illustrated in FIG. 3.

The host projector 150 is provided with a first polarization plate on its projection unit. The host projector 150 projects a left image, which passes through the first polarization plate, onto a screen SC (screen V). On the other hand, the slave projector 151 is provided with a second polarization plate on its projection unit. The second polarization plate has a polarizing axis that is substantially orthogonal to that of the first polarization plate. The slave projector 151 projects a right image, which passes through the second polarization plate, onto the screen SC (screen V). The first polarization plate is fixed to the L lens piece of the pair of light-polarizing glasses 140 worn by the user. The second polarization plate is fixed to the R lens piece thereof. With such a configuration, images appear stereoscopically on the picture screen V formed on the projection screen SC in front of the user who wears the pair of light-polarizing glasses 140. The user can perform input operation on icons displayed in 3D as done in the foregoing embodiments of the invention. Thus, the present variation example produces the same working effects as those of the foregoing embodiments of the invention and the above variation examples.

### Variation Example 4

A fourth variation example of the invention is explained below while referring to FIG. 1. In the foregoing embodiments of the invention and the above variation examples, it is explained that two cameras are used for imaging. However, the scope of the invention is not limited to such an exemplary configuration. It may be modified as long as at least two cameras having different visual angles are used. As the number of cameras used for imaging increases, the amount of information obtained increases. Therefore, it is possible to increase the precision of 3D position information. Infrared cameras may be used if icons are operated mainly with a hand(s). With such a configuration, it is possible to detect the position of a hand, which is a part of the human body that always gives off heat, efficiently.

### Variation Example 5

A fifth variation example of the invention is explained below while referring to FIG. 1. In the foregoing embodiments of the invention and the above variation examples, it is explained that a pair of shutter glasses or a pair of light-polarizing glasses is used. However, the scope of the invention is not limited to such an exemplary configuration. When a parallax barrier or a lenticular lens is used for 3D display without using a pair of glasses, the opening and closing of an eye(s) of a user may be detected for accepting an input through the action of the eye(s). Specifically, in place of actually executing the function assigned to the selected icon (enabling the selection) by changing the mode (form, pattern) of the hand 60 at the selected position, for example, the left eye may be closed for a certain length of time so as to actually execute the function assigned to the selected icon (enable the selection). In addition, for example, a cancellation function may be assigned to the closing of the right eye for a certain length of time. That is, functions may be assigned to a combination of the opening/closing of the eyes. By this means, it is possible to further enhance the user-friendliness of an image input system.

### Variation Example 6

A sixth variation example of the invention is explained below while referring to FIG. 6. The method explained in the second embodiment of the invention, which selects an icon out of icons i displayed one over another as layers in the direction of the depth of a 3D image on the basis of the position of the hand 60 in the depth direction, can be applied to file search (folder search). When the display device 50 is provided with a built-in hard disk drive or when the image signal supplier 300 is a personal computer, a large number of files containing photographs, moving images, and the like are stored therein in the generality of cases. Each name of these files generally contains a string of numerals, symbols, letters, and the like such as, for example, the date of shooting, it is troublesome to search for a target file, that is, a file which a user is looking for, on the basis of its file name. To provide a solution to the above problem, the icons i illustrated in FIG. 6 can be replaced with these files (folders). This enables a user to search for a target file easily by reaching out their hand to files displayed one over another as layers in the depth direction. The image of the file that is displayed as the first file from the front, that is, the image of the currently selected file only, is displayed in an enlarged size. Therefore, for example, in comparison with a case where a plurality of images is arranged for thumbnail display, a user can intuitively search for a target file more efficiently. Therefore, it is possible to provide a file retrieval system that is user friendly.

The entire disclosure of Japanese Patent Application No. 2009-231224, filed Oct. 5, 2009 is expressly incorporated by reference herein.

What is claimed is:

1. An image input system comprising:
a display device that displays a three-dimensional image that includes a plurality of icons for operation;
a plurality of cameras that picks up a plurality of images of a user who faces the three-dimensional image at different visual angles; and
a controller that controls the display device and the plurality of cameras, the controller causes the display device to display the three-dimensional image, the controller performs analysis processing on the plurality of images picked up by the plurality of cameras to obtain and output analysis information that contains three-dimensional position information regarding a most protruding part at a side of the user, the part protruding toward the three-dimensional image;
wherein the plurality of icons includes icons of which positions in a depth direction in the three-dimensional image are not the same, each icon can be identified from the other icons or can be selected out of the icons of which the positions in the depth direction are not the same by using the three-dimensional position information that contains position information in the depth direction.

2. The image input system according to claim 1, wherein the plurality of icons is arranged in such a manner that the icons do not overlap one another in a planar direction along a screen of the display device.

3. The image input system according to claim 2, wherein, among the plurality of icons, a first function is assigned to an icon, or a group of icons, that is relatively high in the depth direction and thus is displayed at a position that is relatively close to the user; a second function is assigned to another icon, or another group of icons, that is lower in the depth direction than the icon or the group of icons mentioned first; and the second function is less frequently used than the first function.

4. The image input system according to claim 1, wherein the plurality of icons has an overlapping part in the planar direction along the screen of the display device; and, in addition, the icons are disposed one over another as layers in the depth direction.

5. The image input system according to claim 1, wherein a function that is assigned to the selected icon is executed when a change in mode of the most protruding part at the user's side toward the three-dimensional image from a first mode to a second mode, which is different from the first mode, is detected.

6. The image input system according to claim 1, wherein the controller causes the display device to display a cursor at a position based on the three-dimensional position information in the three-dimensional image.

7. The image input system according to claim 6, wherein a color tone of the cursor or a shape of the cursor changes depending on the position in the depth direction.

8. The image input system according to claim 6, wherein a plurality of the cursors is displayed in the three-dimensional image.

9. The image input system according to claim 1, wherein the selected icon is displayed in a relatively highlighted manner in comparison with the other icons.

10. The image input system according to claim 1, wherein the most protruding part at the user's side toward the three-dimensional image is a hand of the user; and the mode of the hand, which includes the first mode and the second mode, includes spreading a palm of the hand, clenching a fist, and pointing a finger.
